(19) United States
(12) Patent Application Publication
(10) Pub. No.: US 2019/0300742 A1
(43) Pub. Date: Oct. 3, 2019

(54) Set Including Inks and Treatment Agent, and Recording Method

(71) Applicant: Brother Kogyo Kabushiki Kaisha, Nagoya-shi (JP)

(72) Inventors: Shinpei Ito, Nagoya-shi (JP); Yasuhiro Taga, Kani-shi (JP)

(21) Appl. No.: 16/268,887

(22) Filed: Feb. 6, 2019

(30) Foreign Application Priority Data
Mar. 30, 2018 (JP) 2018-070308

(51) Int. Cl. C09D 11/54; C09D 11/40; C09D 11/322; C09D 11/324; C09D 11/328; D06P 5/30; D06P 1/00; D06P 1/44; D06P 1/52; D06P 1/651

(52) U.S. Cl. CPC C09D 11/54; C09D 11/40; C09D 11/322; C09D 11/324; D06P 1/65118; D06P 5/30; D06P 1/0096; D06P 1/445; D06P 1/5285; C09D 11/328

(57) ABSTRACT

A set includes: a water-based black pigment ink for ink-jet recording; a water-based yellow dye ink for ink-jet recording; a water-based magenta dye ink for ink-jet recording; a water-based cyan dye ink for ink-jet recording; and a treatment agent. The water-based black pigment ink for ink-jet recording includes a carbon black and water; the water-based yellow dye ink for ink-jet recording includes a yellow dye and water; the water-based magenta dye ink for ink-jet recording includes a magenta dye and water; the water-based cyan dye ink for ink-jet recording includes a cyan dye and water; and the treatment agent includes a cationic polymer emulsion.

### CROSS REFERENCE TO RELATED APPLICATION

The present application claims priority from Japanese Patent Application No. 2018-070308 filed on Mar. 30, 2018 the disclosure of which is incorporated herein by reference in its entirety.

### BACKGROUND

### Field of the Invention

The present invention relates to a set including inks and a treatment agent, and a recording method.

### Description of the Related Art

There are suggested a variety of methods of forming a composite black on a recording medium, such as a fabric, by use of color inks in accordance with an ink-jet system (e.g., see Japanese Patent Application Laid-open No. 2009-202491).

When the composite black is formed on the fabric by use of a water-based ink set for ink-jet recording, high water resistance and high abrasion resistance are required (the composite black formed on the fabric needs high water resistance and high abrasion resistance).

In view of the above, an object of the present teaching is to provide a set including inks and a treatment agent that results in a composite black having high water resistance and high abrasion resistance when the composite black is formed on a fabric in accordance with an ink-jet system.

### SUMMARY

According to a first aspect of the present teaching, there is provided a set including: a water-based black pigment ink for ink-jet recording that includes a carbon black and water; a water-based yellow dye ink for ink-jet recording that includes a yellow dye and water; a water-based magenta dye ink for ink-jet recording that includes a magenta dye and water; a water-based cyan dye ink for ink-jet recording that includes a cyan dye and water; and a treatment agent that includes a cationic polymer emulsion.

According to a second aspect of the present teaching, there is provided a recording method for recording on a fabric by using the set as defined in the first aspect, the recording method including: applying the treatment agent to the fabric; and forming a composite black by jetting the water-based black pigment ink, the water-based yellow dye ink, the water-based magenta dye ink, and the water-based cyan dye ink onto the fabric by an ink-jet system.

### BRIEF DESCRIPTION OF THE DRAWINGS

FIG. 1 is a schematic perspective view of an exemplary configuration of an ink-jet recording apparatus of the present teaching.

FIG. 2 schematically depicts an exemplary configuration of the ink-jet recording apparatus of the present teaching.

FIGS. 3A and 3B each depict an example of application of a treatment agent by a recording method of the present teaching.

FIG. 4 is a flowchart indicating the recording method of the present teaching.

### DESCRIPTION OF THE EMBODIMENTS

<Set>

A set of the present teaching is explained. The set of the present teaching includes a water-based black pigment ink, a water-based yellow dye ink, a water-based magenta dye ink, a water-based cyan dye ink, and a treatment agent.

<Water-Based Black Pigment Ink>

The water-based black pigment ink includes a carbon black and water.

The carbon black is exemplified, for example, by furnace black, lamp black, acetylene black, and channel black.

The carbon black may be a self-dispersible carbon black. The self-dispersible carbon black is likely to interact with a cationic polymer emulsion included in the treatment agent. This improves the abrasion resistance of a composite black formed on a fabric (cloth). The self-dispersible carbon black is dispersible in water without using any dispersing agent, for example, owing to the fact that at least one of the hydrophilic functional group and the salt thereof including, for example, a carbonyl group, a hydroxyl group, a carboxylic acid group, a sulfonic acid group, and a phosphoric acid group is introduced into the particles of the carbon black by the chemical bond directly or with any group intervening therebetween. As the self-dispersible carbon black, it is possible to use a self-dispersible carbon black in which the carbon black is subjected to a treatment by any one of methods described, for example, in Japanese Patent Application Laid-open No. 8-3498 corresponding to U.S. Pat. No. 5,609,671, Published Japanese Translation of PCT International Publication for Patent Application No. 2000-513396 corresponding to U.S. Pat. No. 5,837,045, Published Japanese Translation of PCT International Publication for Patent Application No. 2008-524400 corresponding to United States Patent Application Publication No. 2006/0201380, and Published Japanese Translation of PCT International Publication for Patent Application No. 2009-515007 corresponding to United States Patent Application Publication Nos. 2007/0100023 and 2007/0100024. The carbon black which is suitable to perform the treatment as described above is exemplified for example, by MA8 and MA100 produced by Mitsubishi Chemical Corporation, and Carbon Black FW200 produced by Degussa. As the self-dispersible carbon black, it is also allowable to use, for example, any commercially available product. The commercially available product includes, for example, CAB-O-JET (trade name) 200, CAB-O-JET (trade name) 300, and CAB-O-JET (trade name) 400 produced by CABOT CORPORATION; BONJET (trade name) BLACK CW-2 and BONJET (trade name) BLACK CW-3 produced by Orient Chemical Industries, Ltd.; and LIOJET (trade name) WD BLACK 002 produced by Toyo Ink Mfg. Co., Ltd.

The average particle size (average particle diameter) of the carbon black is, for example, equal to or less than 130 nm or in a range of 80 nm to 130 nm. The average particle diameter can be calculated, for example, by performing measurement using a dynamic light scattering particle diameter distribution measuring apparatus “LB-550” manufactured by HORIBA, LTD., and with the intensity of scattered light as the reference for the particle diameter. A sample used for the measurement is, for example, a solution of the pigment, which is diluted such that the solid content amount is 0.02% by weight.

The carbon black(s) may be used alone or in a combination of two or more thereof. The solid content amount of the carbon black(s) in an entire amount of the water-based pigment black ink is, for example, in a range of 0.1% by mass to 20% by mass, in a range of 1% by mass to 15% by mass, or in a range of 2% by mass to 10% by mass.

The water is preferably ion-exchange water or purified water (pure water). The content of the water in the entire amount of the water-based black pigment ink is, for example, in a range of 10% by mass to 90% by mass, in a range of 40% by mass to 80% by mass, or in a range of 50% by mass to 80% by mass. The content of the water in the entire amount of the water-based black pigment ink may be, for example, a balance of the other components.

The water-based black pigment ink may further include a water-soluble organic solvent. The water-soluble organic solvent is exemplified, for example, by a humectant that inhibits the water-based black pigment ink from drying at an end of a nozzle in an ink-jet head and a penetrant that adjusts the drying velocity on a recording medium.

Examples of the humectant include, but not limited to, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyvalent alcohols such as alkylene glycol, glycerol, trimethylolpropane, and trimethylolethane; 2-pyrrolidone; N-methyl-2-pyrrolidone; and 1,3-dimethyl-2-imidazolidinone. The polyalkylene glycol is exemplified, for example, by polyethylene glycol and polypropylene glycol. The alkylene glycol is exemplified, for example, by ethylene glycol, propylene glycol, butylene glycol, diethylene glycol, triethylene glycol, dipropylene glycol, tripropylene glycol, thiodiglycol, and hexylene glycol. Those may be used alone or in a combination of two or more thereof. Among them, a polyvalent alcohol such as alkylene glycol or glycerol is preferably used.

The content of the humectant(s) in the entire amount of the water-based black pigment ink is, for example, in a range of 0% by mass to 95% by mass, in a range of 5% by mass to 80% by mass, or in a range of 5% by mass to 50% by mass.

An example of the penetrant is glycol ether. Examples of the glycol ether include ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, and tripropylene glycol-n-butyl ether. Those may be used alone or in a combination of two or more thereof.

The content of the penetrant(s) in the entire amount of the water-based black pigment ink is, for example, in a range of 0% by mass to 20% by mass, in a range of 0% by mass to 15% by mass, or in a range of 1% by mass to 4% by mass.

The water-based black pigment ink may further include a conventionally known additive, as necessary. The additive is exemplified, for example, by viscosity-adjusting agents, surfactants, pH-adjusting agents, surface tension-adjusting agents, and fungicides. The viscosity-adjusting agents are exemplified, for example, by polyvinyl alcohol, cellulose, and water-soluble resin.

The water-based black pigment ink can be prepared, for example, by uniformly mixing the carbon black(s), the water, and an optionally other additive(s) as necessary, by a conventionally known method, and then removing any non-dissolved matter, with a filter or the like.

<Water-Based Yellow Dye Ink>

The water-based yellow dye ink includes a yellow dye and water.

Examples of the yellow dye include, but not limited to, C. I. Direct Yellows 8, 12, 23, 24, 26, 27, 28, 33, 39, 44, 50, 58, 85, 86, 87, 88, 89, 98, 100, 110, 132, 142, and 173; C. I. Acid Yellows 1, 3, 7, 11, 17, 23, 25, 29, 36, 38, 40, 42, 44, 61, 71, 76, 98, and 99; C. I. Reactive Yellows 2, 3, 17, 25, 37, and 42; and C. I. Food Yellow 3. The yellow dye may be an anionic dye. The anionic dye is likely to interact with the cationic polymer emulsion in the treatment agent. This improves the water resistance of the composite black formed on the fabric (cloth). The water-based yellow dye(s) may be used alone or in a combination of two or more thereof.

The content of the yellow dye(s) in an entire amount of the water-based yellow dye ink is, for example, in a range of 0.1% by mass to 20% by mass, in a range of 1% by mass to 15% by mass, or in a range of 2% by mass to 10% by mass.

The water is preferably ion-exchange water or purified water (pure water). The content of the water in the entire amount of the water-based yellow dye ink is, for example, in a range of 10% by mass to 90% by mass, in a range of 40% by mass to 80% by mass, or in a range of 50% by mass to 80% by mass. The content of the water in the entire amount of the water-based yellow dye ink may be, for example, a balance of the other components.

The water-based yellow dye ink may further include a water-soluble organic solvent and an additive that are similar to those for the water-based black pigment ink.

The water-based yellow dye ink can be prepared, for example, by uniformly mixing the yellow dye(s), the water, and an optionally other additive(s) as necessary, by a conventionally known method, and then removing any non-dissolved matter, with a filter or the like.

<Water-Based Magenta Dye Ink>

The water-based magenta dye ink includes a magenta dye and water.

Examples of the magenta dye include, but not limited to, C.I. Direct Reds 1, 2, 4, 9, 11, 17, 20, 23, 24, 28, 31, 39, 46, 62, 75, 79, 80, 83, 89, 95, 197, 201, 218, 220, 224, 225, 226, 227, 228, 229, and 230; C. I. Acid Reds 1, 6, 8, 9, 13, 14, 18, 26, 27, 32, 35, 37, 42, 51, 52, 80, 83, 85, 87, 89, 92, 94, 106, 114, 115, 133, 134, 145, 158, 180, 198, 249, 256, 265, 289, 315, and 317; C.I. Basic Reds 1, 2, 9, 12, 13, 14, and 37; C.I. Reactive Reds 7, 12, 13, 15, 17, 20, 23, 24, 31, 42, 45, 46, and 59; and C.I. Food Reds 87, 92, and 94. The magenta dye may be an anionic dye. The anionic dye is likely to interact with the cationic polymer emulsion in the treatment agent. This improves the water resistance of the composite black formed on the fabric (cloth). The water-based magenta dye(s) may be used alone or in a combination of two or more thereof.

The content of the magenta dye(s) in an entire amount of the water-based magenta dye ink is, for example, in a range of 0.1% by mass to 20% by mass, in a range of 1% by mass to 15% by mass, or in a range of 2% by mass to 10% by mass.

The water is preferably ion-exchange water or purified water (pure water). The content of the water in the entire amount of the water-based magenta dye ink is, for example, in a range of 10% by mass to 90% by mass, in a range of 40% by mass to 80% by mass, or in a range of 50% by mass to 80% by mass. The content of the water in the entire amount of the water-based magenta dye ink may be, for example, a balance of the other components.

The water-based magenta dye ink may further include a water-soluble organic solvent and an additive that are similar to those for the water-based black pigment ink.

The water-based magenta dye ink can be prepared, for example, by uniformly mixing the magenta dye(s), the water, and an optionally other additive(s) as necessary, by a conventionally known method, and then removing any non-dissolved matter, with a filter or the like.

<Water-Based Cyan Dye Ink>

The water-based cyan dye ink includes a cyan dye and water.

Examples of the cyan dye include, but not limited to, C.I. Direct Blues 1, 6, 15, 22, 25, 41, 71, 76, 77, 80, 86, 90, 98, 106, 108, 120, 158, 163, 168, 199, and 226; C.I. Acid Blues 1, 7, 9, 15, 22, 23, 25, 29, 40, 43, 59, 62, 74, 78, 80, 90, 93, 100, 102, 104, 117, 120, 127, 138, 158, 161, 167, 220, and 234; C.I. Basic Blues 1, 3, 5, 7, 9, 24, 25, 26, 28, and 29; and C.I. Reactive Blues 4, 5, 7, 13, 14, 15, 18, 19, 21, 26, 27, 29, 32, 38, 40, 44, and 100. The cyan dye may be an anionic dye. The anionic dye is likely to interact with the cationic polymer emulsion in the treatment agent. This improves the water resistance of the composite black formed on the fabric (cloth). The cyan dye(s) may be used alone or in a combination of two or more thereof.

The content of the cyan dye(s) in an entire amount of the water-based cyan dye ink is, for example, in a range of 0.1% by mass to 20% by mass, in a range of 1% by mass to 15% by mass, or in a range of 2% by mass to 10% by mass.

The water is preferably ion-exchange water or purified water (pure water). The content of the water in the entire amount of the water-based cyan dye ink is, for example, in a range of 10% by mass to 90% by mass, in a range of 40% by mass to 80% by mass, or in a range of 50% by mass to 80% by mass. The content of the water in the entire amount of the water-based cyan dye ink may be, for example, a balance of the other components.

The water-based cyan dye ink may further include a water-soluble organic solvent and an additive that are similar to those for the water-based black pigment ink.

The water-based cyan dye ink can be prepared, for example, by uniformly mixing the cyan dye(s), the water, and an optionally other additive(s) as necessary, by a conventionally known method, and then removing any non-dissolved matter, with a filter or the like.

<Treatment Agent>

Subsequently, the treatment agent is explained. The treatment agent includes the cationic polymer emulsion.

The cationic polymer emulsion is made, for example, from cationic polymer particles (resin fine particles) and a dispersion medium (e.g., water). The resin fine particles are dispersed in the dispersion medium while having a particular particle size, instead of dissolving in the dispersion medium. Namely, the cationic polymer emulsion includes the dispersion medium and the cationic polymer particles dispersed in the dispersion medium. The cationic polymer emulsion may include a water insoluble cationic polymer or a poorly water soluble cationic polymer. The treatment agent including the cationic polymer emulsion of the present teaching thus improves the water resistance of the composite black formed on the fabric, when compared, for example, with a treatment agent including a water-soluble cationic polymer that forms no emulsion.

The cationic polymer in the cationic polymer emulsion includes, for example, a cationic functional group, such as an organic amine.

The cationic polymer emulsion is exemplified, for example, by a cationic polymer emulsion having a urethane structure and a cationic styrene-acrylic emulsion. If the cationic polymer emulsion has the urethane structure, namely, if the cationic polymer in the cationic polymer emulsion has the urethane structure, a tactile sensation of the fabric on which recording is performed (a tactile sensation of the fabric after recording), such as the feel of the fabric, is improved. The urethane structure may be an ester-based urethane structure. Namely, the cationic polymer may have the ester-based urethane structure. The ester-based urethane structure further improves the tactile sensation of the fabric on which recording is performed (the tactile sensation of the fabric after recording), such as the feel of the fabric. The cationic polymer having the urethane structure, in particular, the cationic polymer having the ester-based urethane structure in a cationic urethane emulsion can form a flexible film when dried. Based on that, it is assumed that the fabric to which the treatment agent is applied is less likely to harden.

A minimum film-forming temperature of the cationic polymer emulsion is preferably equal to or less than 40° C. The minimum film-forming temperature may be, for example, equal to or less than 20° C. or equal to or less than 5° C. The minimum film-forming temperature in the present teaching means, for example, a minimum temperature required to allow the polymer emulsion to become a film by heating. The minimum film-forming temperature can be determined, for example, in accordance with determination of minimum film-forming temperature (JIS K 6828-2:2003 corresponding to ISO2115:1996). Specifically, a polymer emulsion is lightly applied, for example, to an aluminum plate having temperature gradient. Then, the minimum film-forming temperature can be determined, as a temperature at which a dried coating film is formed, by use of a minimum film-forming temperature measurement apparatus. The minimum film-forming temperature measurement apparatus is exemplified, for example, by MINIMUM FILM FORMING TEMPERATURE BAR 90 produced by RHOPOINT INSTRUMENTS LTD.

The cationic polymer emulsion may be privately prepared in-house, or any commercially available product may be used as the cationic polymer emulsion. Examples of the commercially available product include MOWINYL (trade name) 6910 (a cationic polymer emulsion having an ester-based urethane structure) and MOWINYL (trade name) 6901 (a cationic styrene-acrylic emulsion) manufactured by JAPAN COATING RESIN CO., LTD.; and SUPERFLEX (trade name) 620 (a cationic polymer emulsion having an ester-based urethane structure) and SUPERFLEX (trade name) 650 (a cationic polymer emulsion having a urethane structure) manufactured by DKS CO., LTD. (Dai-ichi Kogyo Seiyaku Co., Ltd.). Those may be used alone or in a combination of two or more thereof.

The average particle size (average particle diameter) of the cationic polymer emulsion, namely, the average particle size of particles of the cationic polymer in the cationic urethane emulsion is, for example, in a range of 100 nm to 300 nm. The average particle size can be determined, as the arithmetic mean diameter, by using a dynamic light scattering type particle diameter distribution measuring apparatus LB-500 produced by HORIBA, Ltd.

The cationic polymer emulsion having the urethane structure preferably has at least one of an acrylic structure and a styrene structure in a portion, of the cationic polymer emulsion having the urethane structure, different from the urethane structure. The cationic polymer emulsion having the urethane structure more preferably has the acrylic structure (i.e., a urethane-acrylic emulsion is more preferable). Of the above commercially available products, MOWINYL (trade name) 6910, SUPERFLEX (trade name) 620, and SUPERFLEX (trade name) 650 correspond to the urethane-acrylic emulsion.

A ratio of a part of the urethane structure (a ratio of occupation of the urethane structure, or a ratio of the urethane structure) is preferably equal to or more than 10% by mass, more preferably equal to or more than 20% by mass in the cationic polymer emulsion having the urethane structure. The ratio of the urethane structure means a ratio of the urethane structure to a solid content amount (the cationic polymer having the urethane structure) of the cationic polymer emulsion having the urethane structure. The urethane structure may be preferably a portion obtained from: aliphatic isocyanate; and polyether polyol or polyester polyol.

The content of the cationic polymer emulsion in an entire amount of the treatment agent is, for example, in a range of 1% by mass to 40% by mass, in a range of 2% by mass to 25% by mass, or in a range of 2.5% by mass to 20% by mass. Making the content equal to or more than 2.5% by mass improves the water resistance and abrasion resistance of the fabric on which recording is performed. Making the content equal to or less than 20% by mass improves the tactile sensation of the fabric on which recording is performed (the tactile sensation of the fabric after recording), such as the feel of the fabric. The content means a solid content amount of the cationic polymer emulsion in the entire amount of the treatment agent. Namely, the content is a content of the cationic polymer having the urethan structure in the cationic urethane emulsion in the entire amount of the treatment agent.

The treatment agent may or may not include the cationic polymer emulsion having no urethane structure. In view of the tactile sensation of the fabric after recording, however, the content (% by mass) of the cationic polymer emulsion having no urethane structure is preferably smaller than the content (% by mass) of the cationic polymer emulsion (cationic urethane emulsion) having the urethane structure. From the same point of view, it is preferable for the treatment agent not to virtually include the cationic polymer emulsion having no urethane structure. Namely, it is preferably for the cationic polymer emulsion to include substantially only the cationic polymer emulsion which includes the cationic polymer having the urethane structure. A ratio of the solid content of the cationic urethan emulsion to the total solid content of all the cationic polymer emulsions in the treatment agent is, for example, equal to or more than 50% by mass, equal to or more than 90% by mass, or 100% by mass.

The treatment agent may further include a water-soluble organic solvent. The water-soluble organic solvent is exemplified, for example, by a humectant.

Examples of the humectant include, but not limited to, lower alcohols such as methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones such as acetone; ketoalcohols (ketone alcohols) such as diacetone alcohol; ethers such as tetrahydrofuran and dioxane; polyethers such as polyalkylene glycol; polyvalent alcohols such as alkylene glycol, glycerol, trimethylolpropane, and trimethylolethane; 2-pyrrolidone; N-methyl-2-pyrrolidone; and 1,3-dimethyl-2-imidazolidinone. The polyalkylene glycol is exemplified, for example, by polyethylene glycol and polypropylene glycol. The alkylene glycol is exemplified, for example, by ethylene glycol, propylene glycol, butylene glycol, diethylene glycol, triethylene glycol, dipropylene glycol, tripropylene glycol, thiodiglycol, and hexylene glycol. Those may be used alone or in a combination of two or more thereof. Among them, a polyvalent alcohol, such as glycerol or alkylene glycol including propylene glycol, is preferably used.

The content of the humectant(s) in the entire amount of the treatment agent is, for example, in a range of 0% by mass to 80% by mass, in a range of 2% by mass to 60% by mass, or in a range of 5% by mass to 50% by mass.

The treatment agent may further include a water-soluble organic solvent other than the humectant. The water-soluble organic solvent other than the humectant is exemplified, for example, by a penetrant that adjusts the drying velocity on a recording medium.

As the penetrant, it is possible to use, for example, those exemplified as the penetrants for the water-based black pigment ink. The penetrant(s) may be used alone or in a combination of two or more thereof. The content of the penetrant(s) in the entire amount of the treatment agent is, for example, in a range of 0% by mass to 20% by mass, in a range of 0% by mass to 15% by mass, or in a range of 1% by mass to 4% by mass.

The water-soluble organic solvent may be a glycol-based water-soluble organic solvent of which boiling point is equal to or less than 200° C. (hereinafter, in some cases, referred to as a specific glycol-based solvent). Examples of the specific glycol-based solvent include ethylene glycol (boiling point: 196° C.), propylene glycol (boiling point: 188° C.), 1,2-butanediol (boiling point: 194° C.), and 2,3-butanediol (boiling point: 183° C.). Those may be used alone or in a combination of two or more thereof. The propylene glycol is preferably used because it is harmless to humans and has a good balance between humidity (wettability) and volatility.

A ratio of the content of the specific glycol-based solvent to the total content of the water-soluble organic solvent(s) in the treatment agent is, for example, equal to or more than 80% by mass, equal to or more than 95% by mass, or 100% by mass. The water-soluble organic solvent may include substantially only the specific glycol-based solvent.

The treatment agent may further include water. The water is preferably ion-exchange water or purified water (pure water). The content of the water in the entire amount of the treatment agent is, for example, in a range of 10% by mass to 90% by mass, in a range of 20% by mass to 80% by mass, equal to or more than 40% by mass, or in a range of 40% by mass to 80% by mass. The content of the water in the entire amount of the treatment agent may be, for example, a balance of the other components.

The treatment agent may further include at least one of a nonionic surfactant and a cationic surfactant.

As the nonionic surfactant, a commercially available product may be used.

Examples of the commercially available product include DOBANOX (trade name) series, LEOCOL (trade name) series, LEOX (trade name) series, LAOL, LEOCON (trade name) series, LIONOL (trade name) series, CADENAX (trade name) series, LIONON (trade name) series, and LEOFAT (trade name) series produced by LION SPECIALITY CHEMICALS CO., LTD.; EMULGEN (trade name) series, RHEODOL (trade name) series, EMASOL (trade name) series, EXCEL (trade name) series, AMINON (trade name) series produced by KAO Corporation; and OLFIN (trade name) series produced by Nissin Chemical Industry Co., Ltd.

The cationic surfactant is exemplified, for example, by quaternary ammonium salt, quaternary ammonium ion, primary, secondary, and tertiary amine salt type compounds, alkylamine salt, dialkylamine salt, aliphatic amine salt, alkylpyridinium salt, imidazolinium salt, sulfonium salt, phosphonium salt, and onium salt. Specific examples of the cationic surfactant other than the quaternary ammonium salt and the quaternary ammonium ion include, for example, hydrochlorides and acetates of laurylamine, palm amine, and rosin amine, cetylpyridinium chloride, cetylpyridinium bromide, and dihydroxyethyllaurylamine.

The quaternary ammonium salt is exemplified, for example, by a cationic compound represented by the following formula (1).

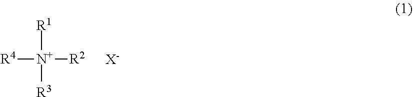

In the formula (1), each of R¹ to R⁴ is a hydrocarbon group having 1 to 30 carbon atoms; R¹ to R⁴ may be identical with each other or different from each other; and X⁻ is an anion.

In the formula (1), each of R¹ to R³ may be an alkyl group having 1 to 5 carbon atoms. The alkyl group having 1 to 5 carbon atoms may have a straight chain or a branched chain, and is exemplified, for example, by methyl group, ethyl group, n-propyl group, isopropyl group, n-butyl group, sec-butyl group, isobutyl group, tert-butyl group, n-pentyl group, isopentyl group, sec-pentyl group, 3-pentyl group, and tert-pentyl group. The alkyl group having 1 to 5 carbon atoms may have a substituent group such as halogen atom. In the formula (1), R¹ to R³ may be identical with each other or different from each other.

In the formula (1), R⁴ may be an alkyl group having 6 to 30 carbon atoms. The alkyl group having 6 to 30 carbon atoms is exemplified, for example, by hexyl group, heptyl group, octyl group, nonyl group, decyl group, lauryl group (dodecyl group), tetradecyl group, and cetyl group (hexadecyl group). The alkyl group having 6 to 30 carbon atoms may have a substituent group such as halogen atom, and may have either a straight chain or a branched chain.

In the formula (1), X⁻ is an anion. Although the anion may be any anion, the anion may be exemplified, for example, by methylsulfate ion, ethylsulfate ion, sulfate ion, nitrate ion, acetate ion, dicarboxylate (e.g., malate, itaconate) ion, tricarboxylate (e.g., citrate) ion, hydroxide ion, and halide ion. When X⁻ is dicarboxylate ion or tricarboxylate ion, dicarboxylate ion or tricarboxylate ion is the counter ion for two or three quaternary ammonium ions (cations obtained by removing X⁻ from the formula (1)).

The cationic compound represented by the formula (1) is exemplified, for example, by lauryltrimethylammonium sulfate, lauryltrimethylammonium chloride, cetyltrimethylammonium chloride, and benzyldimethylalkylammonium chloride. The cationic compound represented by the formula (1) may be privately prepared in-house, or any commercially available product may be used as the cationic compound represented by the formula (1). The commercially available product is exemplified, for example, by Catiogen (trade name) TML, Catiogen (trade name) TMP, and Catiogen (trade name) ES-O produced by DKS CO., LTD. (Dai-ichi Kogyo Seiyaku Co., Ltd.), and Benzalkonium chloride produced by Tokyo Kasei Kogyo Co., Ltd.

The quaternary ammonium ion is exemplified, for example, by a cation obtained by removing X⁻ from the formula (1).

A content (S) of at least one of the nonionic surfactant and the cationic surfactant in the entire amount of the treatment agent is, for example, in a range of 0.05% by mass to 20% by mass, in a range of 0.1% by mass to 10% by mass, or in a range of 0.2% by mass to 5% by mass. The content (S) indicates an active ingredient amount.

It is preferable for the treatment agent not to virtually include an anionic surfactant. The anionic surfactant may interact with the cationic polymer emulsion, which may inhibit the interaction between the pigment in the ink and the cationic polymer emulsion and between the dye in the ink and the cationic polymer emulsion. The content of the anionic surfactant in the entire amount of the treatment agent is, for example, 0% by mass or in a range of 0% by mass to 0.01% by mass.

The treatment agent may further include a conventionally known additive, as necessary. The additive is exemplified, for example, by pH-adjusting agents, viscosity-adjusting agents, surface tension-adjusting agents, and fungicides. The viscosity-adjusting agents are exemplified, for example, by polyvinyl alcohol, cellulose, and water-soluble resin.

In order not to affect the color of the printed matter, it is preferable for the treatment agent not to virtually include a colorant such as a dye and pigment. The content of the colorant in the entire amount of the treatment agent is, for example, in a range of 0% by mass to 1% by mass or in a range of 0% by mass to 0.1% by mass.

The treatment agent can be prepared, for example, by uniformly mixing the cationic polymer emulsion and an optionally other additive(s) as necessary, by a conventionally known method. The treatment agent may be, for example, an aqueous treatment agent (treatment agent-liquid) or a gel treatment agent. When the treatment agent is the aqueous treatment agent (treatment agent-liquid) or the gel treatment agent, the treatment agent can be easily coated on (applied to) the recording medium.

The viscosity of the treatment agent is, for example, equal to or less than 100 mPa·s, equal to or less than 20 mPa·s, or equal to or less than 10 mPa·s. The viscosity is a value measured at 25° C.

As described above, the treatment agent in the set of the present teaching includes the cationic polymer emulsion. Meanwhile, it is preferable for the water-based inks not to virtually include a cationic polymer. The cationic polymer in the water-based inks interacts with the pigment and dye in the water-based inks. This may inhibit the interaction between the pigment and the cationic polymer emulsion in the treatment agent and between the dye and the cationic polymer emulsion in the treatment agent. A total solid content amount (% by mass) of the cationic polymer in the water-based inks is preferably equal to or less than the solid content amount (% by mass) of the cationic polymer emulsion in the treatment agent. The total solid content amount (% by mass) of the cationic polymer in the water-based inks is a total of the solid content amounts of the cationic polymer in the water-based inks which are the water-based black pigment ink, the water-based yellow dye ink, the water-based magenta dye ink, and the water-based cyan dye ink. The solid content amount of the cationic polymer in each of the water-based inks is, for example, 0% by mass, equal to or less than 0.1% by mass, or equal to or less than 0.01% by mass.

As described above, it is preferable for the treatment agent in the set of the present teaching to include the glycol-based water-soluble organic solvent of which boiling point is equal to or less than 200° C. (specific glycol-based solvent). Meanwhile, it is preferable for the water-based inks not to virtually include the specific glycol-based solvent. This is because it is preferable for each of the water-based inks to include, instead of the specific glycol-based solvent, a humectant having higher wettability than that of the specific glycol-based solvent. The total content (% by mass) of the specific glycol-based solvent in the water-based inks is preferably equal to or less than the content (% by mass) of the specific glycol-based solvent in the treatment agent. The total content (% by mass) of the specific glycol-based solvent in the water-based inks is a total of the content amounts of the specific glycol-based solvent in the water-based inks which are the water-based black pigment ink, the water-based yellow dye ink, the water-based magenta dye ink, and the water-based cyan dye ink. The content (% by mass) of the specific glycol-based solvent in each of the water-based inks is, for example, 0% by mass, equal to or less than 10% by mass, or equal to or less than 5% by mass.

The set of the present teaching that includes the water-based ink set and the treatment agent is superior in water resistance and abrasion resistance when the composite black is formed on the fabric. This mechanism is assumed as follows. The dyes included in the water-based yellow dye ink, the water-based magenta dye ink, and the water-based cyan dye ink are typically anionic. The cationic polymer emulsion in the treatment agent counteracts or negates electrical charges of the dyes, and the dyes have a non-aqueous state. This is considered to improve the water resistance of the composite black formed on the fabric. The cationic polymer emulsion in the treatment agent interacts with the pigment in the water-based black pigment ink and stays on the fabric after recording together with the water-based black pigment. This is considered to improve the abrasion resistance of the composite black formed on the fabric. Dyes typically have a low water resistance and pigments typically have a low abrasion resistance. The cationic polymer emulsion in the treatment agent in the set of the present teaching interacts with both the dyes and the pigment. This improves both the water resistance and the abrasion resistance of the composite black formed from the dyes and the pigment. This mechanism, however, just an assumption, and the present teaching is not limited thereto.

The set of the present teaching can be preferably used for recording on the fabric. In addition to that, the set of the present teaching can be used for recording, for example, on any other recording medium than the fabric, such as a recording paper. The fabric includes both of knitted items and textiles. The material of the fabric may be either natural fibers or synthetic fibers. The natural fibers include, for example, cotton and silk. The synthetic fibers include, for example, urethane, acryl, polyester, and nylon.

<Treatment Agent>

Subsequently, a treatment agent of the present teaching is explained. The treatment agent of the present teaching is the treatment agent used for the set of the present teaching, characterized by including the cationic polymer emulsion. The treatment agent of the present teaching is the same as or equivalent to the treatment agent for the set of the present teaching described above. The explanation for the treatment agent described above can thus be incorporated therein.

<Recording Method and Ink-Jet Recording Apparatus>

Subsequently, a recording method of the present teaching is explained.

The recording method of the present teaching is a recording method of recording on a fabric by use of the set according to the present teaching, the method including:

a treatment agent application step of applying the treatment agent on the fabric; and

a composite black formation step of forming the composite black through jetting of the water-based black pigment ink, the water-based yellow dye ink, the water-based magenta dye ink, and the water-based cyan ink, onto a portion to which the treatment agent is applied, in accordance with an ink-jet system.

The set used for the recording method of the present teaching is the same as or equivalent to the set of the present teaching described above. The explanation for the set described above can thus be incorporated therein.

The recording method of the present teaching can be performed, for example, by using an ink-jet recording apparatus of the present teaching described below.

The ink-jet recording apparatus of the present teaching is an ink-jet recording apparatus including: an ink set accommodating section; a treatment agent applying mechanism; and an ink jetting mechanism. The set of the present teaching is accommodated in the ink set accommodating section; the treatment agent for the set is applied to a fabric by the treatment agent applying mechanism; and the water-based black pigment ink, the water-based yellow dye ink, the water-based magenta dye ink, and the water-based cyan dye ink for the set are jetted onto the fabric by the ink jetting mechanism.

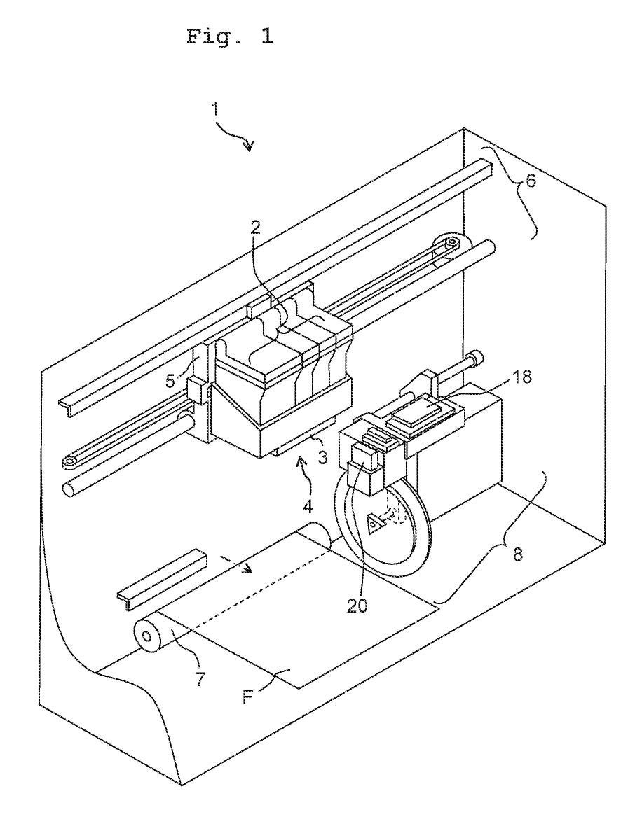

FIG. 1 depicts an exemplary configuration of the ink-jet recording apparatus of the present teaching. As depicted in FIG. 1, an ink-jet recording apparatus 1 includes four ink cartridges 1, an ink jetting mechanism (ink-jet head) 3, a head unit 4, a carriage 5, a driving unit 6, a platen roller 7 and a purge device 8 as main constitutive components or parts of the ink-jet recording apparatus 1.

Each of the four ink cartridges 2 contains one of four water-based inks of black, yellow, magenta, and cyan. For example, the four colors of water-based inks are the water-based black pigment ink, the water-based yellow dye ink, the water-based magenta dye ink, and the water-based cyan dye ink for the set of the present teaching. In this example, a set with the four ink cartridges 2 is explained. However, instead of this set, the present teaching may use an integrated type ink cartridge of which interior is comparted (partitioned) to form a water-based yellow ink accommodating section, a water-based magenta ink accommodating section, a water-based cyan ink accommodating section, and a water-based black ink accommodating section. As a body of the ink cartridge, for example, any conventionally known main body of an ink cartridge may be used.

The ink-jet head 3 disposed on the head unit 4 performs recording on a fabric F. The four ink cartridges 2 and the head unit 4 are provided or arranged on the carriage 5. The driving unit 6 causes the carriage 5 to reciprocate in a linear direction. As the driving unit 6, it is possible to use, for example, a conventionally known driving unit (see, for example, Japanese Patent Application laid-open No. 2008-246821 corresponding to United States Patent Application Publication No. US2008/0241398 A1). The platen roller 7 extends in the reciprocating direction of the carriage 5 and is arranged to face the ink-jet head 3.

The purge device 8 sucks or draws unsatisfactory ink (poor ink) which contains air bubbles, etc., accumulated or trapped in the inside of the ink-jet head 3. As the purge device 8, it is possible to use, for example, a conventionally known purge device (for example, see Japanese Patent Application laid-open No. 2008-246821 corresponding to United States Patent Application Publication No. US2008/0241398 A1).

A wiper member 20 is provided on the purge device 8 at a position on the side of the platen roller 7 such that the wiper member 20 is adjacent to the purge device 8. The wiper member 20 is formed to have a spatula shape, and wipes a nozzle-formed surface of the ink-jet head 3 accompanying with the movement (reciprocating movement) of the carriage 5. In FIG. 1, a cap 18 is provided to cover nozzles of the ink-jet head 3 which is returned to a reset position upon completion of recording, so as to inhibit the water-based inks from drying.

In the ink-jet recording apparatus 1 of the present embodiment, the four ink cartridges 2 are provided, together with the head unit 4, on one carriage 5. The present teaching, however, is not limited to this. In the ink-jet recording apparatus 1, the respective four ink cartridges 2 may be provided on a carriage which is different (separate) from the carriage on which the head unit 4 is provided. Alternatively, the respective four ink cartridges 2 may be arranged and fixed inside the ink-jet recording apparatus 1, rather than being provided on the carriage 5. In such aspects, for example, the four ink cartridges 2 are connected to the head unit 4 provided on the carriage 5 via tubes, etc., and the water-based inks are supplied from the four ink cartridges 2, respectively, to the head unit 4. Further, in these aspects, it is allowable to use four ink bottles having a bottle shape as the ink containers, instead of using the four ink cartridges 2. In such a case, each of the ink bottles is preferably provided with an inlet port via which the ink is poured from the outside to the inside of each of the ink bottles.

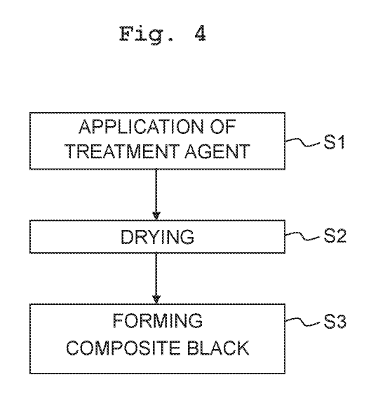

Recording by use of the ink-jet recording apparatus 1 is carried out, for example, as follows (see, FIG. 4).

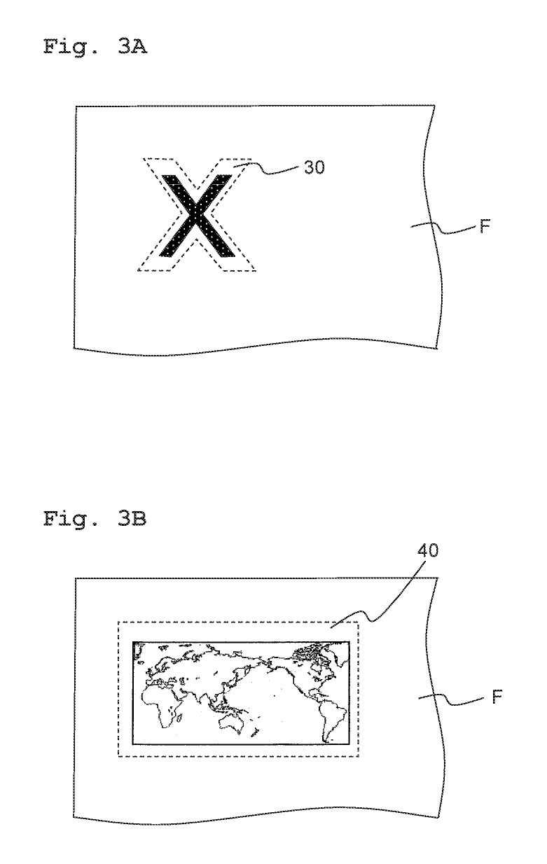

At first, the treatment agent is applied to the fabric (a step S1 of FIG. 4). The application of the treatment agent can be carried out, for example, by means of a spray system, stamp application, brush application, roller application, dipping (immersion in the treatment agent), the ink-jet system, or the like. The treatment agent may be applied to the entirety (entire surface) or part of a recording surface of the fabric. When the treatment agent is applied to part of the recording surface, at least a recording portion, of the recording surface of the fabric, in which recording is (to be) performed by using the water-based ink is an application portion for the treatment agent. When the treatment agent is applied to part of the recording surface, the size of the application portion is preferably larger than the recording portion. For example, as depicted in FIG. 3A, when an image of a letter “X” is recorded on the fabric F, the treatment agent is preferably applied so that an application portion 30 has a line width larger than a line width of the letter. Further, as depicted in FIG. 3B, when a pattern is recorded on the fabric F, the treatment agent is preferably applied so that an application portion 40 is larger than the pattern.

In the treatment agent application step, the application amount of the treatment agent per unit area of the fabric is, for example, 4.7 mg/cm² (30 mg/inch) to 50 mg/cm² (320 mg/inch²). Making the application amount within in the above range improves the water resistance and abrasion resistance of the composite black formed on the fabric.

The recording method of the present teaching may further include a drying step of drying the treatment agent applied in the treatment agent application step (a step S2 of FIG. 4). The drying step inhibits blurring or bleeding in the composite black formed on the fabric, thus improving the water resistance and abrasion resistance. The drying step may be performed before the recording step or after the recording step, and the drying step is preferably performed before the recording step. In the recording method of the present teaching, the drying step is optional. The drying step may be or may not be performed.

The drying may be, for example, air drying (natural drying). Alternatively, the drying may be performed by using any commercially available drying mechanism such as an iron, a hot press machine, a dryer, an oven, a belt conveyer oven or an IR heater. The drying temperature is, for example, in a range of 130° C. to 220° C. When the fabric is cotton, the drying temperature is preferably in a range of 180° C. to 210° C. When the fabric is polyester, the drying temperature is preferably in a range of 140° C. to 160° C. The drying temperature may be, for example, either a temperature of the drying atmosphere or a setting temperature of the drying mechanism. The drying time is, for example, in a range of 30 to 120 seconds.

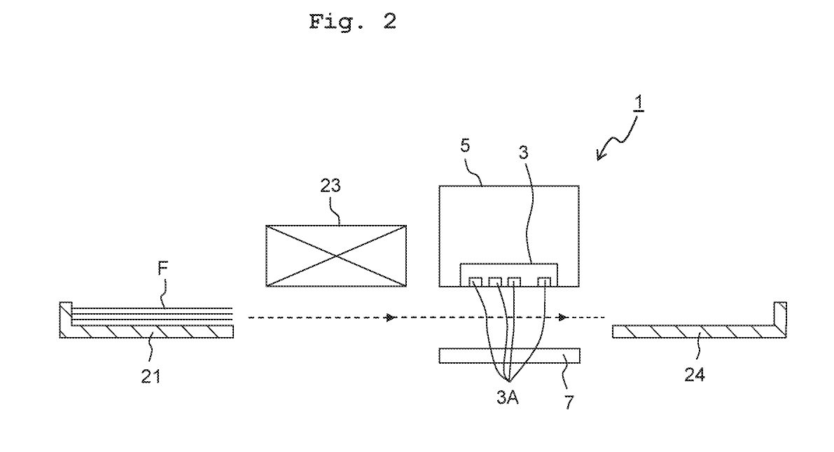

As depicted in FIG. 2, the drying step may be performed by using a drying mechanism 23 provided on the ink-jet recording apparatus 1, as depicted in FIG. 1, of the present teaching. The parts or components in FIG. 2 which are the same as those depicted in FIG. 1 are assigned with the same reference numerals. In FIG. 2, a reference numeral 21 indicates a supply tray (omitted in FIG. 1) and a reference numeral 24 indicates a discharge tray (omitted in FIG. 1); a reference numeral 3A indicates each nozzle formed in the lower surface of the ink-jet head 3. Further, the drying step may be performed, for example, at the outside of the ink-jet recording apparatus.

In the drying step, for example, the mass of the applied treatment agent may be reduced to equal to or less than 50% by mass of the application amount of the treatment agent at the time of application, or to equal to or less than 30% by mass. Making the mass of the treatment agent in the fabric after drying within each of the above ranges improves the water resistance and abrasion resistance of the composite black formed on the fabric. The drying step can be referred to, for example, as a solvent volatilization step of volatilizing a solvent in the treatment agent (e.g., the water and the water-soluble organic solvent) or a mass decrease step of decreasing the mass of the treatment agent.

Subsequently, the composite black is formed by jetting the water-based black pigment ink, the water-based yellow dye ink, the water-based magenta dye ink, and the water-based cyan dye ink from the ink-jet head 3 on the fabric (a step S3 of FIG. 4).

In this example, the treatment agent is used as a pretreatment agent that is applied to the fabric prior to jetting of the water-based black pigment ink, the water-based yellow dye ink, the water-based magenta dye ink, and the water-based cyan dye ink. The present teaching, however, is not limited thereto. In the present teaching, the water-based black pigment ink, the water-based yellow dye ink, the water-based magenta dye ink, and the water-based cyan dye ink may be jetted onto the fabric first, and then the treatment agent may be applied thereto. Alternatively, it is also allowable to simultaneously perform application of the treatment agent on the fabric and jetting of the water-based black pigment ink, the water-based yellow dye ink, the water-based magenta dye ink, and the water-based cyan dye ink on the fabric. In view of inhibiting blurring or bleeding in the composite black formed on the fabric, application of the treatment agent, drying of the treatment agent, and formation of the composite black are preferably performed in that order.

A typical recording method of performing recording on a fabric includes, after the step of forming the composite black, a heat fixing step of performing heat fixing of the water-based black pigment ink, the water-based yellow dye ink, the water-based magenta dye ink, and the water-based cyan dye ink on the fabric. In the recording method of the present teaching, however, the heat fixing step is not indispensable.

The fabric F for which the composite black is formed is discharged from the ink-jet recording apparatus 1. The composite black of the present teaching achieves high water resistance and high abrasion resistance. In FIG. 1, illustration of a supplying mechanism and a discharging mechanism of the fabric F is omitted.

The apparatus depicted in FIG. 1 adopts a serial type ink-jet head. The present teaching, however, is not limited to this. The ink-jet recording apparatus may be an apparatus which adopts a line type ink-jet head.

The recording method of the present teaching may include, for example, a washing step of washing the fabric with water. The washing step may be performed after the step of forming the composite black. The washing step further improves the water resistance of the composite black formed on the fabric.

The recording method of the present teaching as described above may be performed by using an ink-jet recording apparatus provided with the treatment-agent applying mechanism and/or the drying mechanism, or may be performed by using an ink-jet recording apparatus that is not provided with the treatment-agent applying mechanism and/or the drying mechanism. When the recording method is performed by using the ink-jet recording apparatus that is not provided with the treatment-agent applying mechanism and/or the drying mechanism, a user may apply the treatment agent to the fabric by, for example, a spraying method, and/or the user may dry the treatment agent applied to the fabric with an iron or a dryer.

<Composite Black>

Subsequently, the composite black of the present teaching is explained. The composite black of the present teaching is characterized by being formed on a fabric by the recording method of the present teaching.

The composite black of the present teaching is superior in water resistance and abrasion resistance.

<Ink Media Set>

Subsequently, an ink media set of the present teaching is explained. The ink media set of the present teaching is characterized by including the set of the present teaching and a fabric.

According to the ink media set of the present teaching, it is possible to obtain the fabric on which the composite black having high water resistance and high abrasion resistance is formed.

### EXAMPLES

Next, Examples of the present teaching are explained together with Comparative Examples. Note that the present teaching is not limited to or restricted by Examples and Comparative Examples described below.

<Preparation of Water-Based Pigment Ink>

Respective components of Water-based ink composition (Table 1) except for pigment were mixed uniformly or homogeneously; and thus an ink solvent was obtained. Next, the ink solvent was added to each pigment and the obtained mixture was mixed uniformly or homogeneously. After that, the mixture was filtrated through a cellulose acetate type membrane filter (pore size 3.00 μm) produced by TOYO ROSHI KAISHA, LTD., and thus a water-based black pigment ink for ink-jet recording Bk1, a water-based yellow pigment ink for ink-jet recording Y1, a water-based magenta pigment ink for ink-jet recording M1, and a water-based cyan pigment ink for ink jet recording C1 were each obtained as indicated in Table 1.

TABLE 1
Table 1 (following) -

| | | | Bk1 | Y1 | M1 | C1 |
|---|---|---|---|---|---|---|
| Water-based | Pigment | CAB-O-JET (tradename) | 4.00 | — | — | — |
| ink composition | | 300 (*1) | | | | |
| | | C.I. Pigment Yellow 74 | — | 4.00 | — | — |
| | | C.I. Pigment Red 122 | — | — | 4.00 | — |
| | | C.I. Pigment Blue 15:3 | — | — | — | 4.00 |
| | Humectant | Glycerol | 20.00 | 20.00 | 20.00 | 20.00 |
| | Surfactant | Olfine (tradename) | 0.20 | 0.20 | 0.20 | 0.20 |
| | | E1010 (*2) | | | | |
| | | Sunnol (tradename) | 0.20 | 0.20 | 0.20 | 0.20 |
| | | NL1430 (*3) | | | | |

| | | | | |
|---|---|---|---|---|
| Water | balance | balance | balance | balance |

LEGEND
(*1): Self-dispersible carbon black; produced by Cabot Corporation; average particle size 125 nm; the numerical value in Table 1 indicates a solid content amount;
(*2): Nonionic surfactant; produced by Nissin Chemical Industry Co., Ltd.; the numerical value in Table 1 indicates an active ingredient amount;
(*3): Anionic surfactant; produced by Lion Corporation; active ingredient: 28% by weight; the numerical value in Table 1 indicates an active ingredient amount.

The unit of the water-based ink composition is % by mass.

<Preparation of Water-Based Dye Ink>

Respective components of Water-based ink composition (Table 2) were mixed uniformly or homogeneously; and thus a mixture was obtained. After that, the obtained mixture was filtrated through a polytetrafluoroethylene (PTFE)-type membrane filter (pore size 0.20 μm) produced by TOYO ROSHI KAISHA, LTD., and thus a water-based black dye ink for ink-jet recording Bk2, a water-based yellow dye ink for ink-jet recording Y2, a water-based magenta dye ink for ink-jet recording M2, and a water-based cyan dye ink for ink-jet recording C2 were each obtained.

TABLE 2
Table 2 (following) -

| | | | Bk2 | Y2 | M2 | C2 |
|---|---|---|---|---|---|---|
| Water-based | Dye | C.I. Food Black 2 | 4.00 | — | — | — |
| ink composition | | C.I. Direct Yellow 86 | — | 4.00 | — | — |
| | | C.I. Direct Red 83 | — | — | 4.00 | — |
| | | C.I. Acid Blue 90 | — | — | — | 4.00 |
| | Humectant | Glycerol | 20.00 | 20.00 | 20.00 | 20.00 |
| | Surfactant | Olfine (tradename) | 0.20 | 0.20 | 0.20 | 0.20 |
| | | E1010 (*2) | | | | |
| | | Sunnol (tradename) | 0.20 | 0.20 | 0.20 | 0.20 |
| | | NL1430 (*3) | | | | |

| | | | | |
|---|---|---|---|---|
| Water | balance | balance | balance | balance |

LEGEND
(*2): Nonionic surfactant; produced by Nissin Chemical Industry Co., Ltd.; the numerical value in Table 2 indicates an active ingredient amount;
(*3): Anionic surfactant; produced by Lion Corporation; active ingredient: 28% by weight; the numerical value in Table 2 indicates an active ingredient amount.

The unit of the water-based ink composition is % by mass.

### Examples 1 to 9 and Comparative Examples 1 to 5

<Preparation of Treatment>

Respective components of Treatment agent composition (Table 3) were mixed uniformly or homogeneously; and thus the treatment agent for the set of each of Examples 1 to 9 and Comparative Examples 1 to 5 was obtained.

As indicated in Table 3, the sets of Examples 1 to 9 and Comparative Examples 1 to 5 were obtained by combining the water-based pigment inks and the water-based dye inks indicated in Tables 1 and 2 with the treatment agents indicated in Table 3.

With respect to the sets of Examples 1 to 9 and Comparative Examples 1 to 5, (a) Evaluation of water resistance, (b) Evaluation of abrasion resistance, and (c) Evaluation of tactile sensation were performed by the following methods.

(a) Evaluation of Water Resistance

About 1 g of the treatment agent for the set of each of Examples 1 to 8 and Comparative Examples 1 to 5 was uniformly applied by a spray method to a fabric (cotton, sheeting) having a plane size of 15 cm×5 cm. The fabric to which the treatment agent had been applied was dried for 2 minutes by using an iron set to a high temperature (in a range of 180° C. to 210° C.) of which upper limit temperature was 210° C. Subsequently, composite black was formed with the water-based black ink, the water-based yellow ink, the water-based magenta ink, and the water-based cyan ink for the set of each of Examples 1 to 8 and Comparative Examples 1 to 5 by using an ink-jet printer-equipped digital multifunction machine DCP-J4225N produced by BROTHER INDUSTRIES, LTD. The fabric on which the composite black had been formed was washed with water for 5 minutes while shaking the fabric in the water to such an extent that a part of the fabric was not rubbed with another part of the fabric. After washing, the fabric was dried and L*, a*, and b* of the recording portion of the recording surface of the fabric were measured by a spectrophotometer Spectrolino produced by Gretag Macbeth (measurement field: 2°; white reference: Abs (absolute white); light source: D50; density reference: ANSI T). Those values were determined based on the L*a*b* color system (CIE 1976 (L*a*b*) color system) normalized or standardized by Commission Internationale d'Eclairage (CIE) in 1976 (see, JIS Z 8729). Chromaticness C* was calculated from the a* value and the b* value in accordance with the following equation. The difference in chromaticness C* between before washing the fabric and after washing the fabric (ΔC*=C* after washing−C* before washing) was calculated, and evaluation was performed in accordance with the following evaluation criterion. In Example 9, the water resistance was evaluated in the similar manner as above except that polyester (twill) was used as the fabric and the iron was set to medium temperatures (140 to 160° C.) of which upper limit temperature was 160° C.

C*={(a*2)(n*2)}^{1/2}

<Evaluation Criterion for Water Resistance Evaluation>

A: The ΔC* was equal to or less than 0.5

B: The ΔC* exceeded 0.5 and less than 1.5

C: The ΔC* was equal to or more than 1.5

(b) Evaluation of Abrasion Resistance

Composite black was formed on the fabric similarly as the water resistance evaluation, and the portion of the fabric, before washing, in which the composite black had been formed was rubbed by a cotton swab. The amount of ink adhering to the cotton swab due to the rubbing was visually observed, and evaluation was performed in accordance with the following evaluation criterion.

<Evaluation Criterion for Abrasion Resistance Evaluation>

A: According to visual observation, no water-based ink adhered to a surface of the cotton swab after rubbing the fabric, or the area to which the water-based ink adhered was less than approximately 10%.

B: According to visual observation, the water-based ink adhered to a surface of the cotton swab after rubbing the fabric, the area to which the water-based ink adhered was approximately 10% or more, and less than approximately 30%.

C: According to visual observation, the water-based ink adhered to a surface of the cotton swab after rubbing the fabric, the area to which the water-based ink adhered was approximately 30% or more.

(c) Evaluation of Tactile Sensation

10 examinees touched their fingers to the fabric before washing that was made similarly to that of the water resistance evaluation and to an original cotton that was subjected neither to application of the treatment agent nor to formation of the composite black (in Example 9, original polyester that was subjected neither to application of the treatment agent nor to formation of the composite black). The number of examinees who felt that the fabric was harder than the original cotton (in Example 9, the original polyester) was summed up, and evaluation was performed in accordance with the following evaluation criterion.

<Evaluation Criterion for Tactile Sensation Evaluation>

AA: The number of examinees who felt that the fabric was harder than the original cotton was not more than one among ten examinees;

A: The number of examinees who felt that the fabric was harder than the original cotton was two, three, or four among ten examinees;

B: The number of examinees who felt that the fabric was harder than the original cotton was not less than five among ten examinees.

Table 3 indicates the compositions of the treatment agents and the evaluation results of Examples 1 to 9 and Comparative Examples 1 to 5.

TABLE 3
Table 3 (following) -

| | | | Examples | | | | | | | | |
|---|---|---|---|---|---|---|---|---|---|---|---|
| | | | 1 | 2 | 3 | 4 | 5 | 6 | 7 | 8 | 9 |
| Water-based | Water-based black ink | | Bk1 | Bk1 | Bk1 | Bk1 | Bk1 | Bk1 | Bk1 | Bk1 | Bk1 |
| ink set | Water-based yellow ink | | Y2 | Y2 | Y2 | Y2 | Y2 | Y2 | Y2 | Y2 | Y2 |
| | Water-based magenta ink | | M2 | M2 | M2 | M2 | M2 | M2 | M2 | M2 | M2 |
| | Water-based cyan ink | | C2 | C2 | C2 | C2 | C2 | C2 | C2 | C2 | C2 |
| Treatment | Polymer | MOWINYL | 2.00 | 2.50 | 4.00 | 10.00 | 20.00 | 25.00 | — | — | 10.00 |
| agent | emulsion | (trade name) | | | | | | | | | |
| composition | | 6910 (*4) | | | | | | | | | |
| % by mass | | SUPERFLEX | — | — | — | — | — | — | 10.00 | — | — |
| | | (trade name) | | | | | | | | | |
| | | 650 (*5) | | | | | | | | | |
| | | MOWINYL | — | — | — | — | — | — | — | 10.00 | — |
| | | (trade name) | | | | | | | | | |
| | | 6901 (*6) | | | | | | | | | |
| | | SUPERFLEX | — | — | — | — | — | — | — | — | — |
| | | (trade name) | | | | | | | | | |
| | | 820 (*7) | | | | | | | | | |
| | PAA (trade name)-08 (*8) | | — | — | — | — | — | — | — | — | — |
| | Lauryltrimethylammonium | | — | — | — | — | — | — | — | — | — |
| | sulfate (*9) | | | | | | | | | | |
| | Humectant | Propylene | 20.00 | 20.00 | 20.00 | 20.00 | 20.00 | 20.00 | 20.00 | 20.00 | 20.00 |
| | | glycol | | | | | | | | | |
| | Surfactant | Olfine | 0.50 | 0.50 | 0.50 | 0.50 | 0.50 | 0.50 | 0.50 | 0.50 | 0.50 |
| | | (tradename) | | | | | | | | | |
| | | E1010 (*2) | | | | | | | | | |

| | | | | | | | | | | |
|---|---|---|---|---|---|---|---|---|---|---|
| | Water | balance | balance | balance | balance | balance | balance | balance | balance | balance |
| Evaluation | Water resistance | B | A | A | A | A | A | A | B | A |
| | Abrasion resistance | B | A | A | A | A | A | A | A | A |
| | Tactile sensation | AA | AA | AA | AA | A | B | A | B | AA |

| | | | Comparative Examples | | | | |
|---|---|---|---|---|---|---|---|
| | | | 1 | 2 | 3 | 4 | 5 |
| Water-based | Water-based black ink | | Bk1 | Bk1 | Bk1 | Bk1 | Bk2 |
| ink set | Water-based yellow ink | | Y2 | Y2 | Y2 | Y1 | Y2 |
| | Water-based magenta ink | | M2 | M2 | M2 | M1 | M2 |
| | Water-based cyan ink | | C2 | C2 | C2 | C1 | C2 |
| Treatment | Polymer | MOWINYL | — | — | — | 10.00 | 10.00 |
| Agent | emulsion | (trade name) | | | | | |
| composition | | 6910 (*4) | | | | | |
| % by mass | | SUPERFLEX | — | — | — | — | — |
| | | (trade name) | | | | | |
| | | 650 (*5) | | | | | |
| | | MOWINYL | — | — | — | — | — |
| | | (trade name) | | | | | |
| | | 6901 (*6) | | | | | |
| | | SUPERFLEX | — | — | 10.00 | — | — |
| | | (trade name) | | | | | |
| | | 820 (*7) | | | | | |
| | PAA (trade name)-08 (*8) | | 10.00 | — | — | — | — |
| | Lauryltrimethylammonium | | — | 10.00 | — | — | — |
| | sulfate (*9) | | | | | | |
| | Humectant | Propylene | 20.00 | 20.00 | 20.00 | 20.00 | 20.00 |
| | | glycol | | | | | |
| | Surfactant | Olfine | 0.50 | 0.50 | 0.50 | 0.50 | 0.50 |
| | | (tradename) | | | | | |
| | | E1010 (*2) | | | | | |

| | | | | | | |
|---|---|---|---|---|---|---|
| | Water | balance | balance | balance | balance | balance |
| Evaluation | Water resistance | A | A | C | A | C |
| | Abrasion resistance | C | C | B | C | A |
| | Tactile sensation | B | A | A | A | A |

LEGEND
(*4): Cationic urethane-acrylic emulsion (having an ester-based urethane structure); produced by JAPAN COATING RESIN CO., LTD.; the numerical values in Table 3 indicate solid content amounts;
(*5): Cationic urethane-acrylic emulsion; produced by Dai-ichi Kogyo Seiyaku Co., LTD; the numerical value in Table 3 indicates a solid content amount;
(*6): Cationic styrene-acrylic emulsion; produced by JAPAN COATING RESIN CO., LTD.; the numerical value in Table 3 indicates a solid content amount;
(*7): Anionic polymer emulsion; produced by Dai-ichi Kogyo Seiyaku Co., LTD; the numerical value in Table 3 indicates a solid content amount;
(*8): Cationic water-soluble polymer; produced by NITTOBO MEDICAL CO., LTD.
(*9): Cationic substance
(*2): Nonionic surfactant; produced by Nissin Chemical Industry Co., Ltd.; the numerical value in Table 3 indicates an active ingredient amount.

As indicated in Table 3, in Examples 1 to 9, the evaluation results were satisfactory in relation to the water resistance, the abrasion resistance, and the tactile sensation. Examples 1 to 6 having the same conditions except that they had mutually different contents of the cationic polymer emulsion were compared with each other. In Examples 2 to 6 in which the content of the cationic polymer emulsion was equal to or more than 2.5% by mass, the evaluation results of water resistance and abrasion resistance by use of cotton were better than those of Example 1 in which the content of the cationic polymer emulsion was less than 2.5% by mass. In Examples 1 to 5 in which the content of the cationic polymer emulsion was equal to or less than 20% by mass, the evaluation result of tactile sensation by use of cotton was better than that of Example 6 in which the content of the cationic polymer emulsion exceeded 20% by mass. In Examples 1 to 4 in which the content of the cationic polymer emulsion was equal to or less than 10% by mass, the evaluation result of tactile sensation by use of cotton was better than those of Examples 5 and 6 in which the content of the cationic polymer emulsion exceeded 10% by mass. Examples 4, 7, and 8 having the same conditions except that they had mutually different kinds of cationic polymer emulsions were compared with each other. In Examples 4 and 7 in which the cationic polymer emulsion had the urethane structure, the evaluation result of tactile sensation by use of cotton was better than that of Example 8 in which the cationic polymer emulsion had no urethane structure. In Example 4 in which the cationic polymer emulsion had the ester-based urethane structure, the evaluation result of tactile sensation by use of cotton was better than that of Example 7 in which the cationic polymer emulsion had no ester-based urethane structure.

In Comparative Examples 1 and 2 in which the cationic water-soluble polymer or the cationic compound was used instead of the cationic polymer emulsion, the evaluation result of the abrasion resistance by use of cotton was bad. In Comparative Example 3 in which the anionic polymer emulsion was used instead of the cationic polymer emulsion, the evaluation result of the water resistance by use of cotton was bad. In Comparative Example 4 in which the water-based yellow pigment ink, the water-based magenta pigment ink, and the water-based cyan pigment ink were used instead of the water-based yellow dye ink, the water-based magenta dye ink, and the water-based cyan dye ink, the evaluation result of the abrasion resistance by use of cotton was bad. In Comparative Example 5 in which the water-based black dye ink was used instead of the water-based black pigment ink, the evaluation result of the water resistance by use of cotton was bad.

As described above, the set of the present teaching achieves high water resistance and high abrasion resistance when the composite black is formed on the fabric. The way of use of the set of the present teaching is not particularly limited and is widely applicable to recording on a variety of fabric and to recording on any other recording medium than the fabric, such as a recording paper.

What is claimed is:

1. A set, comprising:
a water-based black pigment ink for ink-jet recording that includes a carbon black and water;
a water-based yellow dye ink for ink-jet recording that includes a yellow dye and water;
a water-based magenta dye ink for ink-jet recording that includes a magenta dye and water;
a water-based cyan dye ink for ink-jet recording that includes a cyan dye and water; and
a treatment agent that includes a cationic polymer emulsion.

2. The set according to claim 1, wherein a solid content amount of the cationic polymer emulsion in an entire amount of the treatment agent is in a range of 2.5% by mass to 20% by mass.

3. The set according to claim 2, wherein the solid content amount of the cationic polymer emulsion in the entire amount of the treatment agent is in a range of 2.5% by mass to 10% by mass.

4. The set according to claim 1, wherein a cationic polymer in the cationic polymer emulsion has a urethane structure.

5. The set according to claim 4, wherein the cationic polymer further has an acrylic structure.

6. The set according to claim 1, wherein the cationic polymer in the cationic polymer emulsion has an ester-based urethane structure.

7. The set according to claim 1, wherein the carbon black has an average particle size of equal to or less than 130 nm.

8. The set according to claim 1, wherein the treatment agent further includes a humectant.

9. The set according to claim 8, wherein the humectant includes a polyvalent alcohol.

10. The set according to claim 1, wherein the treatment agent includes at least one of a nonionic surfactant and a cationic surfactant.

11. The set according to claim 1, wherein the carbon black is a self-dispersible carbon black.

12. The set according to claim 1, wherein the treatment agent further comprises a water-soluble organic solvent that consists essentially of propylene glycol.

13. The set according to claim 1, wherein the cationic polymer emulsion consists essentially of a cationic polymer emulsion which includes a cationic polymer having a urethane structure.

14. The set according to claim 1, wherein a total solid content amount of a cationic polymer in water-based inks is equal to or less than a solid content amount of the cationic polymer emulsion in the treatment agent, the water-based inks being the water-based black pigment ink, the water-based yellow dye ink, the water-based magenta dye ink and the water-based cyan dye ink.

15. The set according to claim 14, wherein the water-based inks do not substantially include the cationic polymer.

16. The set according to claim 1, wherein the treatment agent further includes a glycol-based water-soluble organic solvent of which boiling point is equal to or less than 200° C., and
a total content of the glycol-based water-soluble organic solvent in water-based inks is equal to or less than a content of the glycol-based water-soluble organic solvent in the treatment agent, the water-based inks being the water-based black pigment ink, the water-based yellow dye ink, the water-based magenta dye ink and the water-based cyan dye ink.

17. The set according to claim 16, wherein the water-based inks do not substantially include the glycol-based water-soluble organic solvent of which boiling point is equal to or less than 200° C.

18. A recording method for recording on a fabric by using the set as defined in claim 1, the recording method comprising:
applying the treatment agent to the fabric; and
forming a composite black by jetting the water-based black pigment ink, the water-based yellow dye ink, the water-based magenta dye ink, and the water-based cyan dye ink onto the fabric by an ink-jet system.

19. The recording method according to claim 18, further comprising washing the fabric with water after forming the composite black.

20. The recording method according to claim 18, wherein in the application of the treatment agent to the fabric, an application amount, per an area of the fabric, of the treatment agent is in a range of 4.7 mg/cm² to 50 mg/cm².
